(19) United States
(12) Patent Application Publication
(10) Pub. No.: US 2024/0194979 A1
(43) Pub. Date: Jun. 13, 2024

(54) Battery Module and Method of Assembly Thereof

(71) Applicant: SUPERNAL, LLC, Washington, DC (US)

(72) Inventors: Kameron Buckhout, Albany, CA (US); Kevin Lewis, Freemont, CA (US); Loni Cariaga, Irvine, CA (US)

(21) Appl. No.: 18/233,642

(22) Filed: Aug. 14, 2023

Related U.S. Application Data
(60) Provisional application No. 63/431,314, filed on Dec. 8, 2022.

(51) Int. Cl. H01M 10/658; H01M 10/613; H01M 10/647; H01M 10/6554; H01M 10/6556; H01M 50/105; H01M 50/211; H01M 50/291; H01M 50/502; H01M 50/569

(52) U.S. Cl. CPC H01M 10/658; H01M 10/613; H01M 10/647; H01M 10/6554; H01M 10/6556; H01M 50/105; H01M 50/211; H01M 50/291; H01M 50/502; H01M 50/569

(57) ABSTRACT

An example battery module includes: a housing; a cell stack assembly mounted within the housing and comprising a plurality of cell stacks, each cell stack comprising a plurality of cells separated by respective thermal pads, wherein cell stacks of the plurality of cell stacks are separated by respective thermal barrier plates, wherein each cell of the plurality of cells comprises one or more cell tabs; a first compression plate disposed at a first end of the cell stack assembly; a second compression plate disposed at a second end of the cell stack assembly, such that the cell stack assembly is interposed and compressed between the first compression plate and the second compression plate; and a cell tab divider plate mounted to the cell stack assembly, wherein the cell tab divider plate comprises a plurality of slits that accommodate the one or more cell tabs of each cell therethrough.

### CROSS-REFERENCE TO RELATED APPLICATION

The present application claims priority to U.S. Provisional Application No. 63/431,314 filed Dec. 8, 2022, the contents of which are hereby incorporated by reference in its entirety.

### BACKGROUND

Batteries are used in many applications including consumer electronics, electric vehicles, robots, and power-grid storage. A battery goes through many cycles of charging and discharging throughout its life.

An example battery includes several battery modules, each battery module having a respective plurality of battery cells. The battery may heat up during charging, and particularly during fast charging rates (e.g., high coulomb rates). Further, during periods of high demand on the battery, the battery may heat up substantially.

High temperatures reduce the lifespan of the battery, and may lead to an increase in the risk of a thermal runaway event (e.g., an event where a strong exothermic chain reaction occurs within a battery cell, and the battery cell enters an uncontrollable, self-heating state that could result in ejection of gas, shrapnel, and/or particulates). It may thus be desirable to configure the battery with thermal protection features.

It is with respect to these and other considerations that the disclosure made herein is presented.

### SUMMARY

The present disclosure describes implementations that relate to a battery module and method of assembly thereof.

In a first example implementation, the present disclosure describes a battery module. The battery module includes: a housing; a cell stack assembly mounted within the housing and comprising a plurality of cell stacks, each cell stack comprising a plurality of cells separated by respective thermal pads, wherein cell stacks of the plurality of cell stacks are separated by respective thermal barrier plates, wherein each cell of the plurality of cells comprises one or more cell tabs; a first compression plate disposed at a first end of the cell stack assembly; a second compression plate disposed at a second end of the cell stack assembly, opposite the first end, such that the cell stack assembly is interposed and compressed between the first compression plate and the second compression plate; and a cell tab divider plate mounted to the cell stack assembly, wherein the cell tab divider plate comprises a plurality of slits that accommodate the one or more cell tabs of each cell therethrough.

In a second example implementation, the present disclosure describes a method of assembling the battery module of the first example implementation.

The foregoing summary is illustrative only and is not intended to be in any way limiting. In addition to the illustrative aspects, implementations, and features described above, further aspects, implementations, and features will become apparent by reference to the drawings and the following detailed description.

### BRIEF DESCRIPTION OF THE FIGURES

FIG. 1 an exploded perspective view of a battery module, according to exemplary embodiments of the present invention.

FIG. 2 illustrates a side view of a battery cell, according to exemplary embodiments of the present invention.

FIG. 3 illustrates a perspective view of a cell stack, according to exemplary embodiments of the present invention.

FIG. 4 illustrates a perspective view of a partial assembly of the battery module of FIG. 1 showing a cell stack mounted to a first compression plate, according to exemplary embodiments of the present invention.

FIG. 5 illustrates a perspective view of a partial assembly of the battery module of FIG. 1 showing a cell stack and thermal barrier plate mounted to the partial assembly of FIG. 4, according to exemplary embodiments of the present invention.

FIG. 6 illustrates a perspective view of a partial assembly of the battery module of FIG. 1 showing mounting a coldplate to a cell stack assembly, according to exemplary embodiments of the present invention.

FIG. 7 illustrates a perspective view of a partial assembly of the battery module of FIG. 1 showing the coldplate mounted to the cell stack assembly, according to exemplary embodiments of the present invention.

FIG. 8 illustrates a perspective view of a partial assembly of the battery module of FIG. 1 showing a cell tab divider plate being mounted to a cell stack assembly, according to exemplary embodiments of the present invention.

FIG. 9 illustrates a perspective view of a partial assembly of the battery module of FIG. 1 showing the cell tab divider plate mounted to the cell stack assembly, according to exemplary embodiments of the present invention.

FIG. 10 illustrates a perspective view of a partial assembly of the battery module of FIG. 1 including a cell stack assembly and a cell tab divider plate being mounted to a housing, according to exemplary embodiments of the present invention.

FIG. 11 illustrates a perspective view of a partial assembly of the battery module of FIG. 1 showing the cell stack assembly mounted within the housing, according to exemplary embodiments of the present invention.

FIG. 12 illustrates mounting a bus bar assembly to the partial assembly of FIG. 11, according to exemplary embodiments of the present invention.

FIG. 13 illustrates a perspective view of the battery module of FIG. 1 in an assembled state, according to exemplary embodiments of the present invention.

FIG. 14 is a flowchart of a method for assembling the battery module of FIG. 1, according to exemplary embodiments of the present invention.

### DETAILED DESCRIPTION

Disclosed herein are systems, assemblies, and methods for a battery module. The disclosed systems, assemblies, and methods are applicable to any type of battery (e.g., lithium-ion batteries, batteries having silicon-alloy/graphite blend anode combined with a nickel rich lithium nickel manganese cobalt oxide as cathode, lithium metal batteries, etc.).

The disclosed system may be utilized in any device or application that uses batteries. For example, the batteries may be used to power electric motors of a vehicle, including but not limited to a ground vehicle (i.e., an automobile), a sea vehicle (such as a boat), or a flying craft (such as an aerial, floating, soaring, hovering, airborne, aeronautical aircraft, airplane, plane, spacecraft, a helicopter, an airship, or an unmanned aerial vehicle, a vertical take-off and landing (VTOL) craft, or a drone). The disclosed embodiments of the present invention may be used in any of these applications in order to obtain advantages such as reducing weight of the battery, improving mechanical strength of the battery, improving fire protection of the battery (e.g., active functional safety and/or predictive functional safety), reducing the likelihood of a thermal runaway event, and/or maintaining robust packaging of the battery.

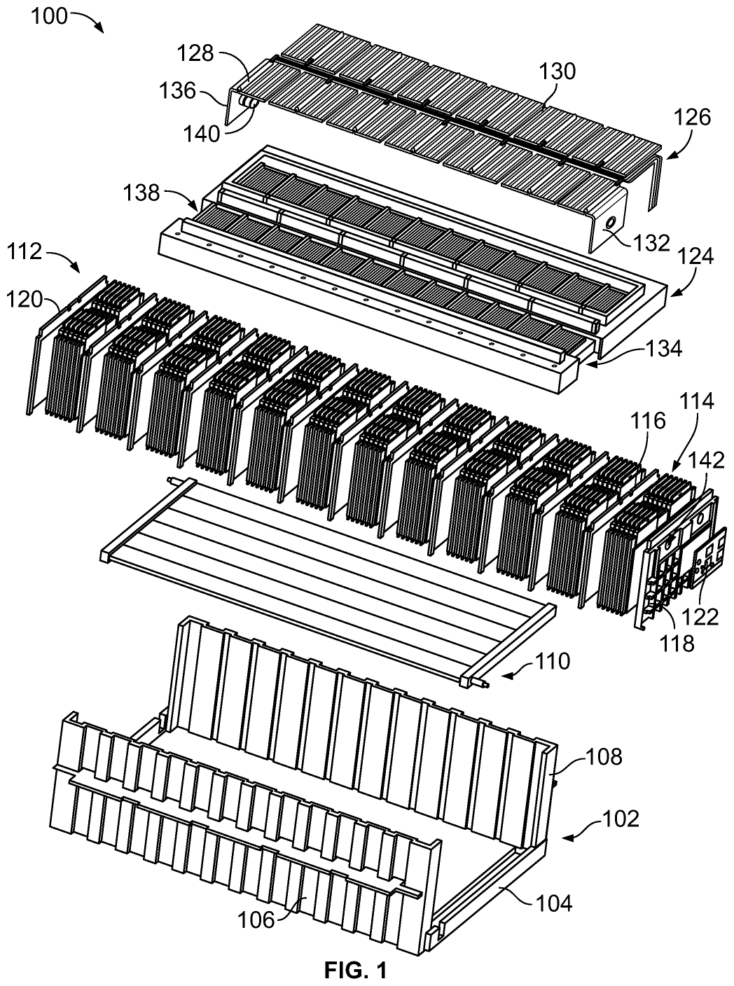

FIG. 1 illustrates an exploded perspective view of a battery module 100, according to exemplary embodiments of the present invention. The battery module 100 can be one of a plurality of battery modules that form a battery used in a vehicle, for example.

In some embodiments, the battery module 100 may include a housing 102. In an example, the housing 102 may have a U-shape (e.g., has a yoke shape), such that the housing 102 has a base 104, a first side plate 106 at a first end of the base 104, and a second side plate 108 at a second end of the base 104.

In an example, the battery module 100 also includes a coldplate 110. As described in more details below, the coldplate 110 may be configured to cool the battery cells of the battery module 100 if the battery module 100 is configured to be liquid-cooled. However, in other examples, the battery module 100 may be air cooled and might not include the coldplate 110. Rather the housing 102 or other components of the battery module 100 may have fins or other features that facilitate air cooling of the battery module 100.

The coldplate 110 may include a flat plate that is configured to be in direct or indirect contact with the battery cells that generate heat during operation of the battery module 100. The flat plate may be made of materials with high thermal conductivity, such as copper or aluminum. As described in more details below, a liquid coolant, such as water or a specialized fluid, can be pumped through channels within the coldplate 110 to absorb the heat generated by the battery cells. The heated coolant may then be carried away from the coldplate 110 to a heat exchanger or radiator where it is cooled before being recirculated back to the coldplate 110. This process may help regulate the temperature of the battery module 100.

In some embodiments, the battery module may 100 include a cell stack assembly 112. In one example, the cell stack assembly 112 can be mounted to the coldplate 110 if the battery module 100 includes the coldplate 110. In another example, a composite plate may replace the coldplate 110, and the cell stack assembly 112 may be mounted to the composite plate such that the composite plate is interposed between the cell stack assembly 112 and an interior surface of the base 104. In another example, the cell stack assembly 112 may be mounted directly to the base 104 of the housing 102.

In some embodiments, the cell stack assembly 112 may comprise a plurality of cell stacks such as cell stack 114, each cell stack including a respective plurality of battery cells. In an example, the battery cells of a given cell stack may be separated by thermal pads (e.g., silicon foam pads) for thermal insulation. Further, in some embodiments, the cell stacks may be separated from each other via respective thermal barrier plates such as thermal barrier plate 116.

As depicted in FIG. 1, the cell stacks may be interposed between a first compression plate 118 and a second compression plate 120. In some embodiments, the compression plates 118, 120 may be configured to apply pressure to the cell stacks within the cell stack assembly 112 to hold the battery cells tightly together and maintain even pressure across all cells in the cell stack assembly 112.

In some embodiments, the battery module 100 may also include a module management unit (MMU) or battery controller 122. In an example, the battery controller 122 may be mounted in a depression or receptacle formed in the first compression plate 118 as shown in FIG. 1. However, in other examples, the battery controller 122 can be mounted at other locations (e.g., the second compression plate 120, the base 104, the first side plate 106, or the second side of the housing 102).

In some embodiments, the battery controller 122 may include one or more processors or microprocessors and may include data storage (e.g., memory, transitory computer-readable medium, non-transitory computer-readable medium, etc.). The data storage may have stored thereon instructions that, when executed by the one or more processors of the battery controller 122, cause the battery controller 122 to perform operations described herein. The battery controller 122 can also include a communication interface (wires or wireless) that facilitates communication with external computing devices, servers, or the cloud.

In an example, the battery controller 122 may be configured as a printed circuit board (PCB). A PCB mechanically supports and electrically connects electronic components (e.g., microprocessors, integrated chips, capacitors, resistors, etc.) using conductive tracks, pads, and other features etched from one or more sheet layers of copper laminate onto and/or between sheet layers of a nonconductive substrate. Components are generally soldered onto the PCB to both electrically connect and mechanically fasten them to it.

In some embodiments, the battery controller 122 may be configured as an electronic regulator that monitors and controls the charging and discharging of the battery module 100, for example. In an example, the battery controller 122 may be configured to measure voltages of the battery module 100 and stop charging them when a desired voltage is reached.

In some embodiments, the battery controller 122 may also monitor and control parameters of the battery module 100. For example, the battery controller 122 may monitor and control battery module voltage or cell voltage, charging and discharge rates of the battery module 100, etc. In an example, the battery controller 122 may control the power flow to and from the battery module 100 based on power demand from the various consumers (e.g., electric motors).

In some embodiments, the battery controller 122 may also perform operations associated with predicting future condition of the battery module 100 and whether a thermal runaway event might occur, for example. The battery controller 122 may also provide information indicative of a state of the battery module 100 to external devices (e.g., external computing devices, servers, or the cloud) and receive instructions and information from such external devices.

In some embodiments, the battery module 100 may further include a cell tab divider plate 124 mounted to the cell stack assembly 112. As described in more details below, the cell tab divider plate 124 may include a plurality of slits that accommodate the positive and negative cell terminals or tabs of each battery cell therethrough. This way, the cell tabs protrude from the cell tab divider plate 124 to allow access thereto.

In some embodiments, the battery module 100 may also include a bus bar assembly 126 mounted to the cell tab divider plate 124 such that the bus bar assembly 126 has access to the cell terminals/tabs, which protrude through the slits of the cell tab divider plate 124. Particularly, the bus bar assembly 126 can include a positive bus bar 128 (positive rail) having access to the positive terminals or tabs of the battery cells, and a negative bus bar 130 (negative rail) having access to the negative tabs of the battery cells.

In some embodiments, the positive bus bar 128 and the negative bus bar 130 may be configured as metal strips that are used to connect the positive and negative tabs of the battery cells to an external consumer such as an electric motor. The positive bus bar 128 and the negative bus bar 130 can be made of copper or aluminum, for example, as these materials have high conductivity and are able to handle high currents without overheating.

In some embodiments, the positive bus bar 128 and the negative bus bar 130 may have mounting features (e.g., fasteners) that facilitate mounting them to the compression plates 118, 120. For example, the positive bus bar 128 may have a tab 132 that can be inserted through a slot 134 in the cell tab divider plate 124 to be mounted to the first compression plate 118, and can have another tab 136 that can be inserted through a slot 138 in the cell tab divider plate 124 to be mounted to the second compression plate 120.

For example, the tab 136 may have a cylindrical component 140 mounted thereto, and a similar cylindrical component may be mounted to the tab 132. The cylindrical component 140 can be inserted into respective holes formed in the second compression plate 120, and the corresponding cylindrical component of the tab 132 can be inserted into a hole 142 in the first compression plate 118 to attach the positive bus bar 128 to the compression plates 118, 120.

In some embodiments, the bus bar assembly 126 may also be configured as a voltage sensor. Particularly, the bus bar assembly 126 can provide sensor information to the battery controller 122 indicative of a voltage level of the cell stack assembly 112.

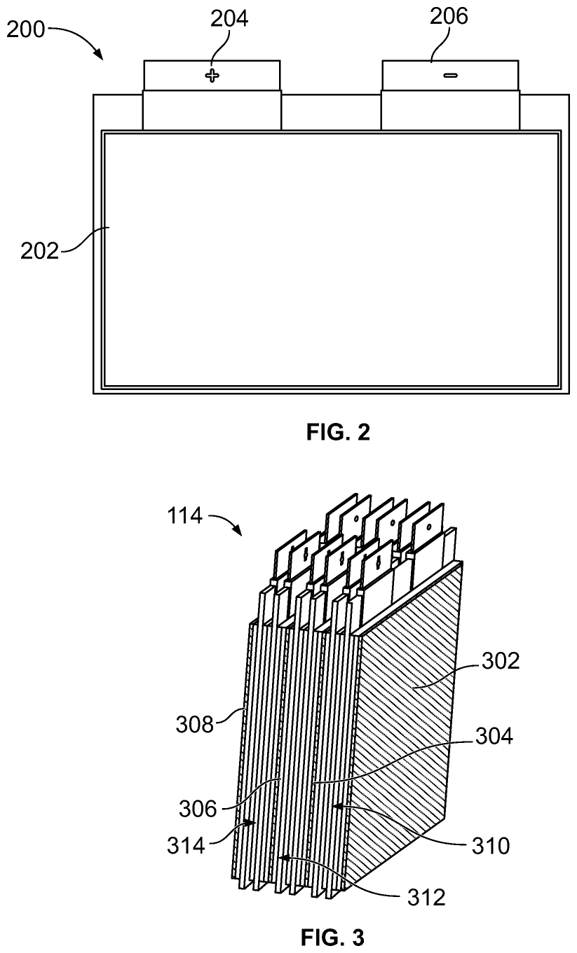

Steps of assembling the battery module 100 and details related to each of the components of the battery module 100 are described next with respect to FIGS. 2-13.

FIG. 2 illustrates a side view of a battery cell 200, according to exemplary embodiments of the present invention. In an example embodiment, the battery cell 200 may be configured as a pouch battery cell, also referred to as a pouch cell, which is a type of rechargeable lithium-ion battery. The battery cell 200 has a cell body 202 that is configured as a flexible, rectangular-shaped polymer or metal pouch, which houses the electrodes and electrolyte of the battery cell 200.

The battery cell 200 can be made of several layers, including two electrodes (an anode and a cathode) separated by a porous membrane soaked in a liquid or gel-like electrolyte, for example. The electrodes and electrolyte are then enclosed in a flexible pouch (e.g., the cell body 202), which is sealed to prevent leakage and contamination.

In some embodiments, the battery cell 200 may have a positive tab 204 (e.g., positive terminal) and a negative tab 206 (e.g., negative terminal). The positive tab 204 may be the end of the battery cell 200 that has a higher electric potential than the negative tab 206. Electrons flow out of the battery cell 200 via the positive tab 204 to the positive bus bar 128, then to an external circuit, then return to the battery cell 200 via the negative tab 206.

The battery cell 200 as a pouch cell may be characterized by lower internal resistance, which allows for higher energy efficiency and faster charging rates, compared to other types of battery cells, such as cylindrical or prismatic cells. Pouch cells may also be lighter and more space-efficient, rendering them suited for application where weight and size are relevant factors.

As an example for illustration, the battery cell 200 can be a 32 Ampere-hour (Ah) rechargeable lithium-ion battery cell. The “32 Ah” designation indicates that the battery cell 200 has a capacity of 32 ampere-hours, which means it can deliver an electric current of 1 ampere for 32 hours, 2 amperes for 16 hours, and so on. However, the embodiments described herein are not limited to pouch cells, and other types of cells are contemplated.

Several battery cells similar to the battery cell 200 can be stacked together to form a cell stack such as the cell stack 114. Multiple battery cells may be connected in series or parallel to achieve the desired voltage and capacity for a particular application.

FIG. 3 illustrates a perspective view of the cell stack 114, according to exemplary embodiments of the present invention. As depicted in FIG. 3, several battery cells similar to the battery cell 200 may be stacked adjacent to each other to form the cell stack 114, such that respective positive and negative tabs of the cells are pointing in the same direction (e.g., upward in FIG. 3). In the example embodiment illustrated in FIG. 3, six cells are stacked together. However, more or fewer cells could be used in a stack.

The battery cells of the cell stack 114 may be separated from each other via thermal pads (e.g., thermal foam pads). Particularly, the cell stack 114 may have four thermal pads: thermal pad 302, thermal pad 304, thermal pad 306, and thermal pad 308. The battery cells of the cell stack 114 thus may be interposed between the thermal pad 302 at one end and the thermal pad 308 at the other end.

Further, the six-cell stack of the cell stack 114 is configured in three pairs of adjacent or interfacing cells. Each pair of adjacent or interfacing cells may be separated from each other by a respective thermal pad. For example, a pair of cells 310 may be separated from a pair of cells 312 via the thermal pad 304. Similarly, the pair of cells 312 may be separated from a pair of cells 314 via the thermal pad 306.

In some embodiments, the thermal pads 302-308 may be configured as thermal interface materials that are flexible to accommodate cell expansion during operation (e.g., during charging) of the battery module 100. In an example, the thermal pads 302-308 can be configured as high-temperature silicon foam pads that can transfer heat between the battery cells (e.g., the pairs of cells 310, 312, 314) and the coldplate 110, for example, or any other heat sink component. In an example, the thermal pads 302-308 may be made of silicone rubber, which is a flexible and compressible material that can conform to irregular surfaces of the battery cells (which can bulge during operation) and provide a low thermal resistance path for heat transfer.

The thermal pads 302-308 can be used in various forms, such as sheets or custom-cut shapes to match the shape and size of the battery cells, and they can have different thicknesses to suit specific battery application requirements. The thermal pads 302-308 can be configured to have a particular high-temperature rating that indicates their ability to withstand elevated temperatures without breaking down or losing their thermal conductivity properties. In an example, the thermal pads 302-308 can operate at temperatures ranging from −40° C. to over 200° C.

After the cell stack 114 is formed or assembled, it can then be mounted to the first compression plate 118.

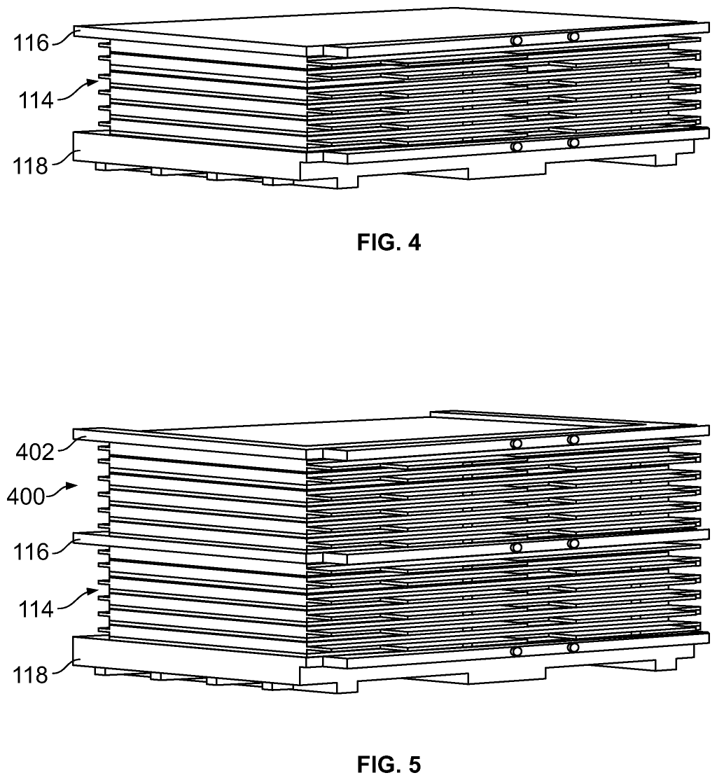

FIG. 4 illustrates a perspective view of a partial assembly of the battery module 100 showing the cell stack 114 mounted to the first compression plate 118, according to exemplary embodiments of the present invention. In some embodiments, the cell stack 114 can be positioned in a manufacturing fixture where it is aligned with and mounted to the first compression plate 118. The thermal barrier plate 116 is then mounted to the cell stack 114 on an opposite side relative to the first compression plate 118. More cell stacks similar to the cell stack 114 can be formed and mounted to the partial assembly of FIG. 4.

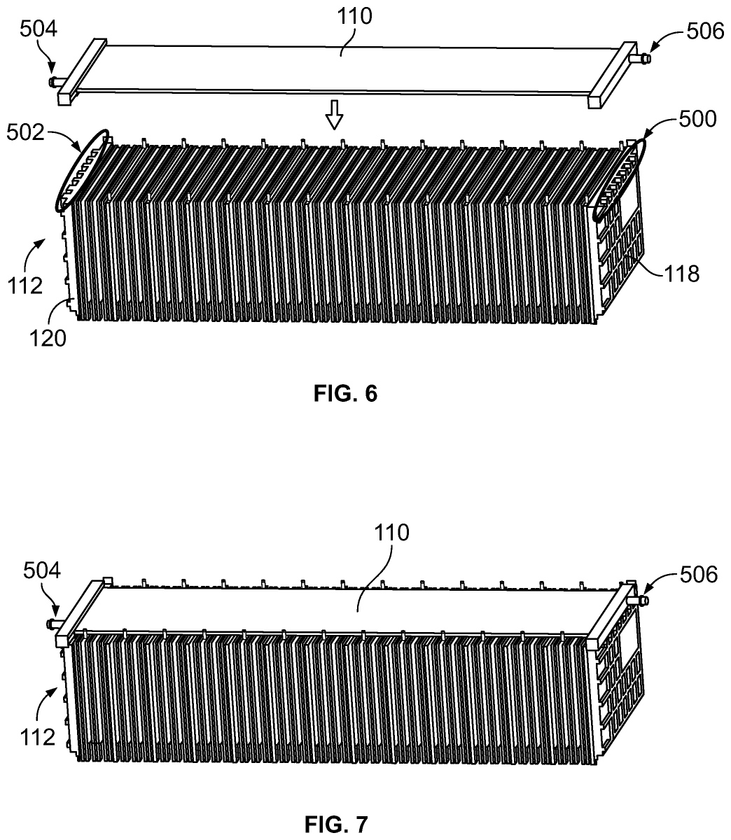

FIG. 5 illustrates a perspective view of a partial assembly of the battery module 100 showing a cell stack 400 and thermal barrier plate 402 mounted to the partial assembly of FIG. 4, according to exemplary embodiments of the present invention. This process can be repeated sequentially until the desired number of cell stacks are stacked in series. The second compression plate 120 can then be mounted to the last cell stack in the cell stack assembly 112. For example, as shown in FIG. 1, twelve cell stacks may be assembled between the first compression plate 118 and the second compression plate 120, with eleven thermal barrier plates interposed between, and respectively separating, the cell stacks.

In some embodiments, the compression plates 118, 120 may be configured to apply pressure to the cell stacks of the cell stack assembly 112. This way, the compression plates 118, 120 hold the cell stacks tightly together and maintain even pressure across all cell stacks in the battery module 100.

In an example, the compression plates 118, 120 can be made of a rigid material, such as aluminum or stainless steel. In one example, the compression plates 118, 120 can have features like holes or slots to allow for ventilation and cooling, and they may also include integrated thermal management systems such as cooling fins or heat pipes to dissipate heat generated during battery operation.

In some embodiments, the compression plates 118, 120 may also prevent the cell stacks from moving or shifting during operation, which can cause damage to the cell stacks or reduce the overall efficiency and lifespan of the battery module 100. By applying even pressure across all cell stacks, the compression plates 118, 120 may help to maintain consistent performance and prevent premature failure of the battery module 100.

Further, the thermal barrier plates interposed between the cell stacks may be configured to thermally insulate the individual cell stacks from each other. This way, if a thermal runaway event occurs in one cell stack, it does not propagate to neighboring cell stacks, or at least the rate of propagation is substantially reduced. Further, the thermal barrier plates may also configured as structural elements that render the cell stack assembly 112 structurally rigid and robust.

As mentioned above, in an example embodiment, the battery module 100 may include the coldplate 110 for liquid cooling of the cell stack assembly 112. In this example embodiment, once the cell stack assembly 112 is completed, the coldplate 110 can be mounted thereto.

FIG. 6 illustrates a perspective view of a partial assembly of the battery module 100 showing mounting the coldplate 110 to the cell stack assembly 112, according to exemplary embodiments of the present invention. For example, while maintaining pressure on the cell stack assembly 112 (e.g., via the compression plates 118, 120), the cell stack assembly 112 can be flipped or rotated such that the cell tabs (e.g., the positive tab 204 and the negative tab 206) are facing downward, thereby exposing bottom side of the battery cells and the compression plates 118, 120.

In some embodiments, a structural adhesive may then be applied to bottom of the compression plates 118, 120, at region 500 (of the first compression plate 118) and region 502 (of the second compression plate 120) that are circled in FIG. 6. An example structural adhesive is epoxy, which can include a two-part adhesive that is made up of a resin and a hardener. When mixed together in the correct proportions, the two components chemically react to form a strong, durable bond.

FIG. 7 illustrates a perspective view of a partial assembly of the battery module 100 showing the coldplate 110 mounted to the cell stack assembly 112, according to exemplary embodiments of the present invention. The coldplate 110 can be lowered to interface with and be mounted to the cell stack assembly 112 as shown in FIG. 7. The compression plates 118, 120 and the thermal barrier plates interposed between the cell stacks may be configured as locating features that facilitate mounting the coldplate 110 to the cell stack assembly 112.

The strong bond of the structural adhesive may ensure that the coldplate 110 is affixed to the cell stack assembly 112. In an example, the partial assembly shown in FIG. 7 is left in a manufacturing fixture for a particular period of time to allow the structural adhesive to cure.

In an example, the coldplate 110 may have a first port 504 (e.g., an inlet port) and a second port 506 (e.g., an outlet port). The coldplate 110 can have one or more quick-connect fittings mounted to the coldplate 110 at the first port 504 and the second port 506 to facilitate connecting coolant fluid lines to and from a heat exchanger. A pump may facilitate circulating fluid between the heat exchanger and the coldplate 110.

Coolant fluid received, e.g., via the first port 504, flows through channels or passages within the coldplate 110 to absorb the heat generated by the cell stack assembly 112. The heated coolant may then be discharged from the second port 506 and carried away from the coldplate 110 and into a heat exchanger or radiator where it is cooled before being recirculated back to the coldplate 110. This process may help regulate the temperature of the battery module 100.

In the example embodiment where the coldplate 110 is not used, a plate made of a light weight composite material may replace the coldplate 110.

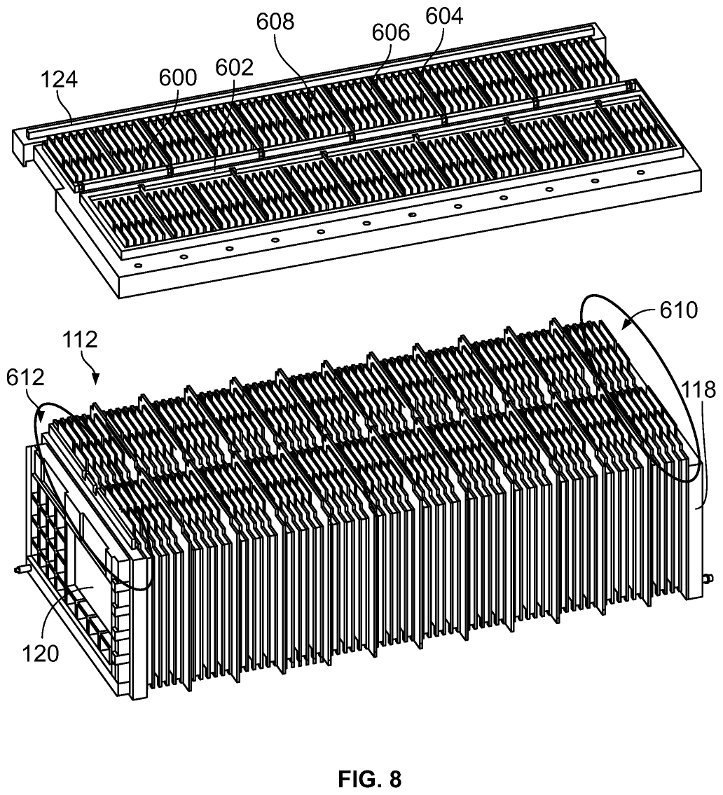

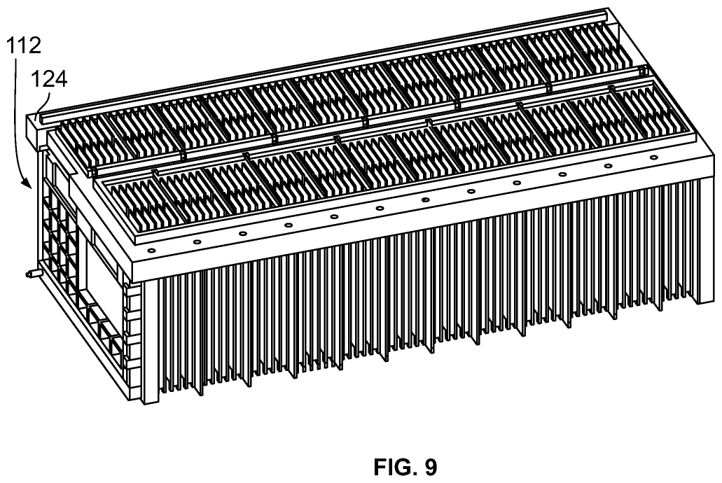

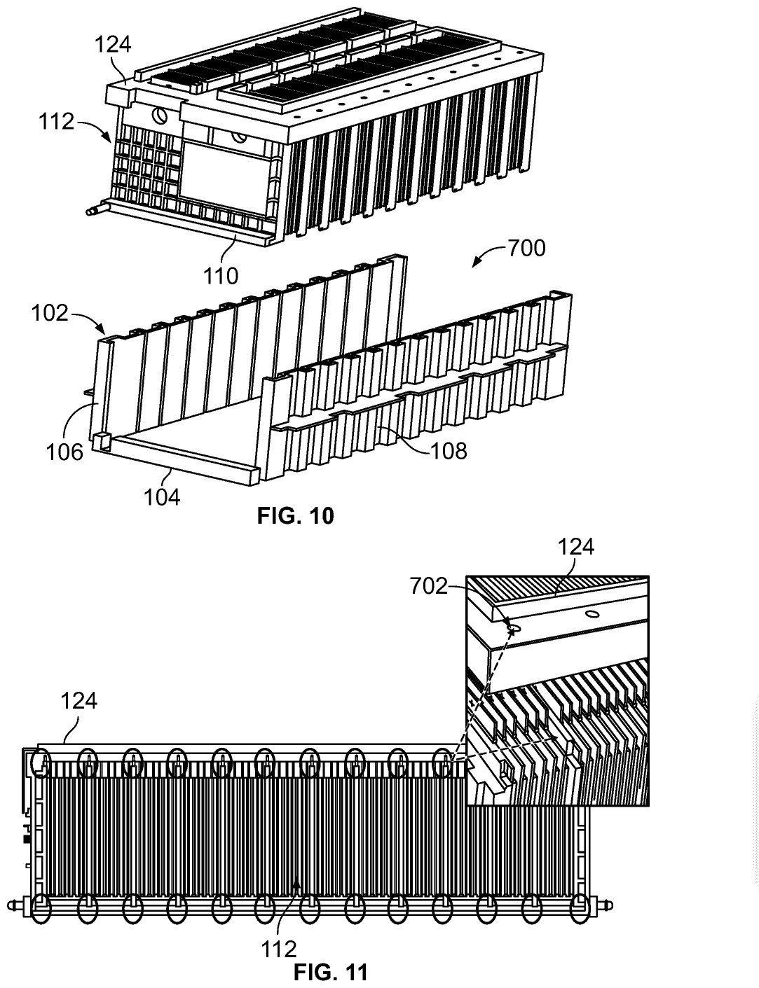

FIG. 8 illustrates a perspective view of a partial assembly of the battery module 100 showing the cell tab divider plate 124 being mounted to the cell stack assembly 112, according to exemplary embodiments of the present invention, and FIG. 9 illustrates a perspective view of a partial assembly of the battery module 100 showing the cell tab divider plate 124 mounted to the cell stack assembly 112, according to exemplary embodiments of the present invention. As shown in FIG. 8, in an example embodiment, the cell tab divider plate 124 may have a central longitudinal rib 600 and a central longitudinal rib 602 that are parallel to each other.

The central longitudinal ribs 600, 602 may be linear structural elements that protrude upward from a surface of the cell tab divider plate 124, and they may be configured to separate and isolate the positive tabs of the battery cells from the negative tabs thereof. The cell tab divider plate 124 may also have lateral ribs such as lateral rib 604 and lateral rib 606 that separate and isolate the cell stacks from each other. In other words, each cell stack may be compartmentalized between two respective lateral ribs. Additionally, the cell tab divider plate 124 may have slits, such as slits 608, between the lateral ribs to allow the positive and negative tabs of the battery cells to protrude upward, thereby providing access to the bus bar assembly 126.

To mount the cell tab divider plate 124 to the cell stack assembly 112, the cell stack assembly 112 is rotated, while maintaining pressure on the cell stack assembly 112, such that the cell positive and negative tabs are facing upward and the coldplate 110 is at the bottom. A structural adhesive can then be applied to the top portions of the compression plates 118, 120, at region 610 (of the first compression plate 118) and region 612 (of the second compression plate 120), which are circled in FIG. 8.

The cell tab divider plate 124 may then mounted atop the cell stack assembly 112 as shown in FIG. 9. The compression plates 118, 120 provide locating features for the cell tab divider plate 124 to be mounted thereon. In an example, the partial assembly shown in FIG. 9 is left in a manufacturing fixture for a particular period of time to allow structural adhesive to cure. The partial assembly of FIG. 9 can then be mounted within the housing 102.

FIG. 10 illustrates a perspective view of a partial assembly of the battery module 100 including the cell stack assembly 112 and the cell tab divider plate 124 being mounted to the housing 102, according to exemplary embodiments of the present invention, and FIG. 11 illustrates a perspective view of a partial assembly of the battery module 100 showing the cell stack assembly 112 mounted within the housing 102, according to exemplary embodiments of the present invention.

The base 104 and the side plates 106, 108 of the housing 102 may form an enclosure with internal space 700 configured to receive the partial assembly of FIG. 9. In an example, the housing 102 can be made of a composite material capable of withstanding high temperatures associated with operating the battery module 100. The composite material can also render the housing 102 having a light weight. In an example, during manufacturing of the housing 102, grain structure of the composite material of the housing 102 may be formed in a way to direct the thermal energy down towards the coldplate 110 during operation of the battery module 100.

In example, while maintaining pressure on the partial assembly of FIG. 9, the partial assembly may be positioned above the housing 102. Prior to inserting the partial assembly into the housing 102, structural adhesive may be applied to the housing 102 at the locations circled in FIG. 11.

In an example, the cell tab divider plate 124 can have access holes such as hole 702 shown in FIG. 11, and the side plates 106, 108 of the housing 102 can have posts protruding upward and configured to be inserted into the access holes of the cell tab divider plate 124 when the cell tab divider plate 124 is mounted to the housing 102. In this example, a structural adhesive can also be added to the access holes prior to mounting the partial assembly of FIG. 9 to the housing 102. The bus bar assembly 126 and the battery controller 122 can be mounted next.

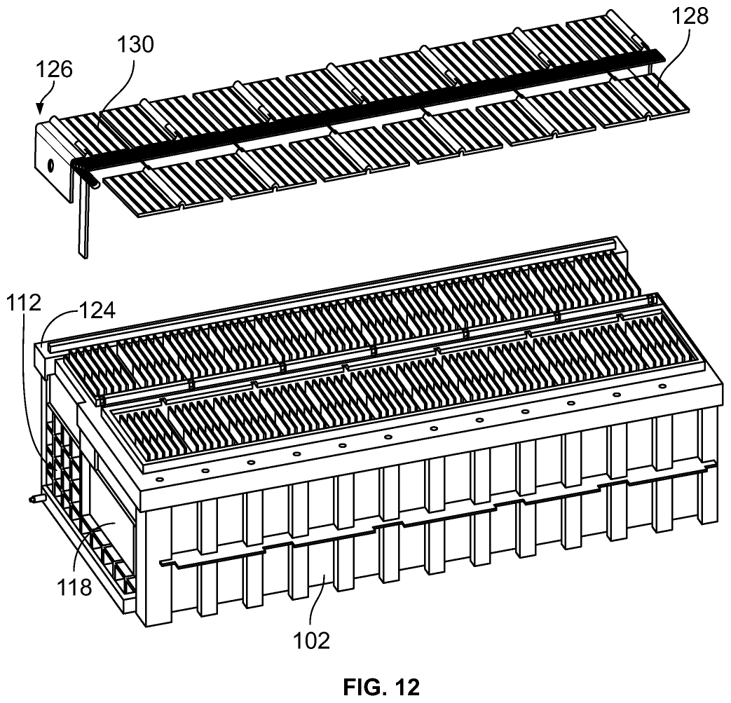

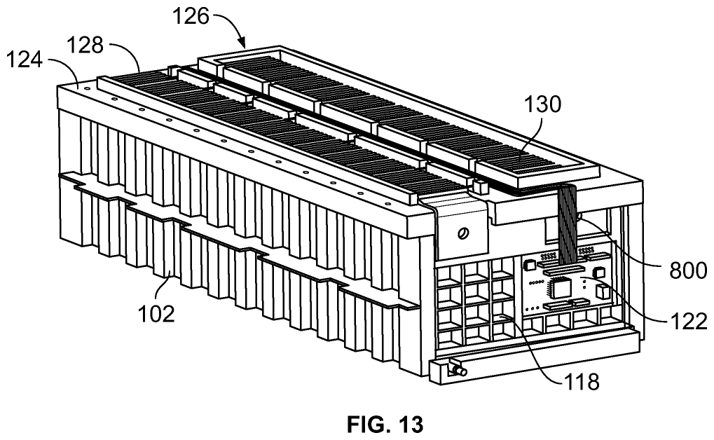

FIG. 12 illustrates mounting the bus bar assembly 126 to the partial assembly of FIG. 11, according to exemplary embodiments of the present invention, and FIG. 13 illustrates a perspective view of the battery module 100 in an assembled state, according to exemplary embodiments of the present invention. The bus bar assembly 126 is mounted atop the partial assembly of FIG. 11 such that the positive bus bar 128 is electrically coupled to the positive tabs of the battery cells of all the cell stacks, and the negative bus bar 130 is electrically coupled to the negative tabs of the battery cells of all the cell stacks.

The battery controller 122 can then be mounted externally to the compression plate 118 as shown in FIG. 13. The bus bar assembly 126 can have a conductive strip 800 that couples the bus bar assembly 126 to the battery controller 122. This way, the bus bar assembly 126 may operate as a voltage sensor configured to provide sensor information indicative of a voltage of the cell stack assembly 112 to the battery controller 122. As such, the battery controller 122 can monitor and control charging and discharging the battery module 100 to maintain its optimal performance and lifespan, for example.

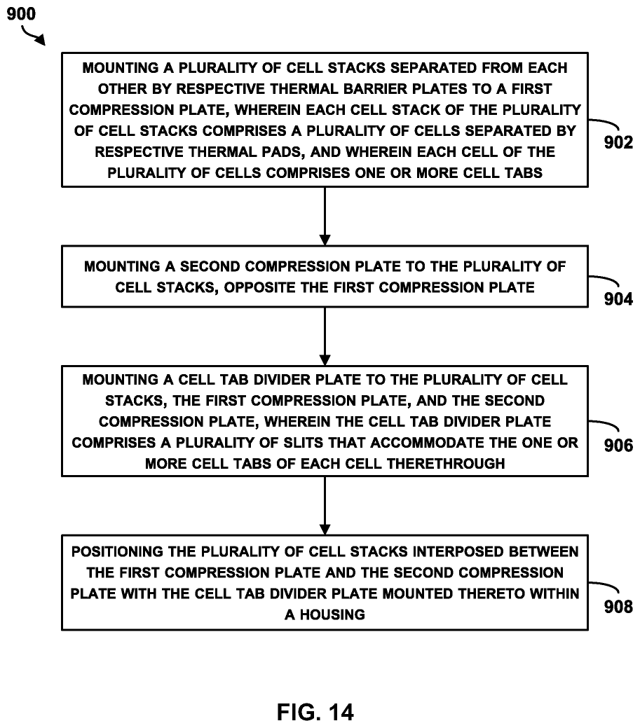

FIG. 14 is a flowchart of a method 900 for assembling the battery module 100, according to exemplary embodiments of the present invention. The method 900 may include one or more operations, functions, or actions as illustrated by one or more of steps 902-908.

Although the steps are illustrated in a sequential order, these steps may also be performed in parallel, and/or in a different order than those described herein. Also, the various steps may be combined into fewer steps, divided into additional steps, and/or removed based upon the desired implementation. It should be understood that for this and other processes and methods disclosed herein, flowcharts show functionality and operation of one possible implementation of present examples. Alternative implementations are included within the scope of the examples of the present disclosure in which functions may be executed out of order from that shown or discussed, including substantially concurrent or in reverse order, depending on the functionality involved, as would be understood by those reasonably skilled in the art

At a step 902, the method 900 may include mounting a plurality of cell stacks (of the cell stack assembly 112) separated from each other by respective thermal barrier plates to the first compression plate 118, wherein each cell stack of the plurality of cell stacks comprises a plurality of cells separated by respective thermal pads, and wherein each cell of the plurality of cells comprises one or more cell tabs.

At a step 904, the method 900 may also include mounting the second compression plate 120 to the plurality of cell stacks, opposite the first compression plate 118.

At a step 906, the method 900 may also include mounting the cell tab divider plate 124 to the plurality of cell stacks, the first compression plate 118, and the second compression plate 120, wherein the cell tab divider plate 124 comprises a plurality of slits (e.g., the slits 608) that accommodate the one or more cell tabs of each cell therethrough.

At a step 908, the method 900 may also include positioning the plurality of cell stacks interposed between the first compression plate 118 and the second compression plate 120 with the cell tab divider plate 124 mounted thereto within the housing 102.

The method 900 can further include other steps to assemble the battery module 100 as described throughout herein.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Implementations of the present disclosure can thus relate to one of the enumerated example implementation (EEEs) listed below.

EEE 1 is a battery module comprising: a housing; a cell stack assembly mounted within the housing and comprising a plurality of cell stacks, each cell stack comprising a plurality of cells separated by respective thermal pads, wherein cell stacks of the plurality of cell stacks are separated by respective thermal barrier plates, wherein each cell of the plurality of cells comprises one or more cell tabs; a first compression plate disposed at a first end of the cell stack assembly; a second compression plate disposed at a second end of the cell stack assembly, opposite the first end, such that the cell stack assembly is interposed and compressed between the first compression plate and the second compression plate; and a cell tab divider plate mounted to the cell stack assembly, wherein the cell tab divider plate comprises a plurality of slits that accommodate the one or more cell tabs of each cell therethrough.

EEE 2 is the battery module of EEE 1, wherein the housing comprises: a base; a first side plate at a first end of the base; and a second side plate at a second end of the base, wherein the cell stack assembly is mounted within the housing and interposed between the first side plate and the second side plate.

EEE 3 is the battery module of EEE 2, further comprising: a coldplate mounted within the housing, between the cell stack assembly and the base of the housing, wherein the coldplate comprises a plurality of channels formed therein to allow coolant to flow therethrough.

EEE 4 is the battery module of EEE 3, wherein the coldplate comprises: a first port configured to receive coolant; and a second port for discharging the coolant.

EEE 5 is the battery module of any of EEEs 3-4, wherein the coldplate is mounted to the first compression plate and the second compression plate.

EEE 6 is the battery module of any of EEEs 1-5, further comprising: a bus bar assembly mounted to the cell tab divider plate such that the bus bar assembly contacts the one or more cell tabs of each cell.

EEE 7 is the battery module of EEE 6, wherein the one or more cell tabs comprise a positive tab and a negative tab protruding through respective slits of the cell tab divider plate, wherein the bus bar assembly comprises a positive bus bar contacting the positive tab and a negative bus bar contacting the negative tab.

EEE 8 is the battery module of EEE 7, wherein the cell tab divider plate comprises one or more longitudinal ribs configured to separate respective positive tabs of the plurality of cells from respective negative tabs thereof.

EEE 9 is the battery module of any of EEEs 6-8, wherein the bus bar assembly is configured as a voltage sensor.

EEE 10 is the battery module of any of EEEs 1-9, wherein the respective thermal pads separating the plurality of cells of each cell stack comprise silicon foam pads.

EEE 11 is the battery module of any of EEEs 1-10, wherein the cell tab divider plate comprises respective lateral ribs that separate the plurality of cell stacks from each other.

EEE 12 is the battery module of EEE 11, wherein plurality of slits are interposed between two respective lateral ribs.

EEE 13 is the battery module of any of EEEs 1-12, wherein respective cells of the plurality of cells are configured as pouch cells, each pouch cell having a cell body that is configured as a flexible, rectangular-shaped polymer or metal pouch.

EEE 14 is the battery module of any of EEEs 1-13, wherein the plurality of cells separated by the respective thermal pads comprise: pairs of interfacing cells separated from each other via the respective thermal pads.

EEE 15 is a method for assembling the battery module of any of EEEs 1-14. For example, the method comprises: mounting a plurality of cell stacks separated from each other by respective thermal barrier plates to a first compression plate, wherein each cell stack of the plurality of cell stacks comprises a plurality of cells separated by respective thermal pads, and wherein each cell of the plurality of cells comprises one or more cell tabs; mounting a second compression plate to the plurality of cell stacks, opposite the first compression plate; mounting a cell tab divider plate to the plurality of cell stacks, the first compression plate, and the second compression plate, wherein the cell tab divider plate comprises a plurality of slits that accommodate the one or more cell tabs of each cell therethrough; and positioning the plurality of cell stacks interposed between the first compression plate and the second compression plate with the cell tab divider plate mounted thereto within a housing.

EEE 16 is the method of EEE 15, wherein mounting the plurality of cell stacks separated from each other by respective thermal barrier plates to the first compression plate comprises: mounting a cell stack to a first compression plate; mounting a thermal barrier plate to the cell stack, opposite the first compression plate; and sequentially mounting respective cell stacks separated by respective thermal barrier plates to the thermal barrier plate.

EEE 17 is the method of any of EEEs 15-16, further comprising: forming each cell stack of the plurality of cell stacks, wherein each cell stack comprises pairs of interfacing cells separated from each other via the respective thermal pads.

EEE 18 is the method of any of EEEs 15-17, further comprising: mounting a coldplate within the housing between the plurality of cell stacks and a base of the housing, wherein the coldplate comprises a plurality of channels formed therein to allow coolant to flow therethrough.

EEE 19 is the method of any of EEEs 15-18, further comprising: mounting a bus bar assembly to the cell tab divider plate such that the bus bar assembly contacts the one or more cell tabs of each cell.

EEE 20 is the method of EEE 19, wherein the one or more cell tabs comprise a positive tab and a negative tab protruding through respective slits of the cell tab divider plate, wherein the bus bar assembly comprises a positive bus bar and a negative bus bar, and wherein mounting the bus bar assembly to the cell tab divider plate comprises: mounting the bus bar assembly such that the positive bus bar contacts the positive tab, and the negative bus bar contacts the negative tab.

What is claimed is:

1. A battery module comprising:
a housing;
a cell stack assembly mounted within the housing and comprising a plurality of cell stacks, each cell stack comprising a plurality of cells separated by respective thermal pads, wherein cell stacks of the plurality of cell stacks are separated by respective thermal barrier plates, wherein each cell of the plurality of cells comprises one or more cell tabs;
a first compression plate disposed at a first end of the cell stack assembly;
a second compression plate disposed at a second end of the cell stack assembly, opposite the first end, such that the cell stack assembly is interposed and compressed between the first compression plate and the second compression plate; and
a cell tab divider plate mounted to the cell stack assembly, wherein the cell tab divider plate comprises a plurality of slits that accommodate the one or more cell tabs of each cell therethrough.

2. The battery module of claim 1, wherein the housing comprises:
a base;
a first side plate at a first end of the base; and
a second side plate at a second end of the base, wherein the cell stack assembly is mounted within the housing and interposed between the first side plate and the second side plate.

3. The battery module of claim 2, further comprising:
a coldplate mounted within the housing, between the cell stack assembly and the base of the housing, wherein the coldplate comprises a plurality of channels formed therein to allow coolant to flow therethrough.

4. The battery module of claim 3, wherein the coldplate comprises:
a first port configured to receive coolant; and
a second port for discharging the coolant.

5. The battery module of claim 3, wherein the coldplate is mounted to the first compression plate and the second compression plate.

6. The battery module of claim 1, further comprising:
a bus bar assembly mounted to the cell tab divider plate such that the bus bar assembly contacts the one or more cell tabs of each cell.

7. The battery module of claim 6, wherein the one or more cell tabs comprise a positive tab and a negative tab protruding through respective slits of the cell tab divider plate, wherein the bus bar assembly comprises a positive bus bar contacting the positive tab and a negative bus bar contacting the negative tab.

8. The battery module of claim 7, wherein the cell tab divider plate comprises one or more longitudinal ribs configured to separate respective positive tabs of the plurality of cells from respective negative tabs thereof.

9. The battery module of claim 6, wherein the bus bar assembly is configured as a voltage sensor.

10. The battery module of claim 1, wherein the respective thermal pads separating the plurality of cells of each cell stack comprise silicon foam pads.

11. The battery module of claim 1, wherein the cell tab divider plate comprises respective lateral ribs that separate the plurality of cell stacks from each other.

12. The battery module of claim 11, wherein plurality of slits are interposed between two respective lateral ribs.

13. The battery module of claim 1, wherein respective cells of the plurality of cells are configured as pouch cells, each pouch cell having a cell body that is configured as a flexible, rectangular-shaped polymer or metal pouch.

14. The battery module of claim 1, wherein the plurality of cells separated by the respective thermal pads comprise:
pairs of interfacing cells separated from each other via the respective thermal pads.

15. A method for assembling a battery module, the method comprising:
mounting a plurality of cell stacks separated from each other by respective thermal barrier plates to a first compression plate, wherein each cell stack of the plurality of cell stacks comprises a plurality of cells separated by respective thermal pads, and wherein each cell of the plurality of cells comprises one or more cell tabs;
mounting a second compression plate to the plurality of cell stacks, opposite the first compression plate;
mounting a cell tab divider plate to the plurality of cell stacks, the first compression plate, and the second compression plate, wherein the cell tab divider plate comprises a plurality of slits that accommodate the one or more cell tabs of each cell therethrough; and
positioning the plurality of cell stacks interposed between the first compression plate and the second compression plate with the cell tab divider plate mounted thereto within a housing.

16. The method of claim 15, wherein mounting the plurality of cell stacks separated from each other by respective thermal barrier plates to the first compression plate comprises:
mounting a cell stack to a first compression plate;
mounting a thermal barrier plate to the cell stack, opposite the first compression plate; and
sequentially mounting respective cell stacks separated by respective thermal barrier plates to the thermal barrier plate.

17. The method of claim 15, further comprising:
forming each cell stack of the plurality of cell stacks, wherein each cell stack comprises pairs of interfacing cells separated from each other via the respective thermal pads.

18. The method of claim 15, further comprising:
mounting a coldplate within the housing between the plurality of cell stacks and a base of the housing, wherein the coldplate comprises a plurality of channels formed therein to allow coolant to flow therethrough.

19. The method of claim 15, further comprising:
mounting a bus bar assembly to the cell tab divider plate such that the bus bar assembly contacts the one or more cell tabs of each cell.

20. The method of claim 19, wherein the one or more cell tabs comprise a positive tab and a negative tab protruding through respective slits of the cell tab divider plate, wherein the bus bar assembly comprises a positive bus bar and a negative bus bar, and wherein mounting the bus bar assembly to the cell tab divider plate comprises:
mounting the bus bar assembly such that the positive bus bar contacts the positive tab, and the negative bus bar contacts the negative tab.
